(19) United States
(12) Patent Application Publication
(10) Pub. No.: US 2025/0296023 A1
(43) Pub. Date: Sep. 25, 2025

(54) BLOWER FILTER ASSEMBLY

(71) Applicant: WATT FUEL CELL CORP., Mt. Pleasant, PA (US)

(72) Inventors: Caine M. FINNERTY, Mount Pleasant, PA (US); Paul DEWALD, Scottdale, PA (US); Mathew ISENBERG, North Canton, OH (US)

(21) Appl. No.: 18/863,402

(22) PCT Filed: Jan. 30, 2023
(86) PCT No.: PCT/US2023/011826

§ 371 Date: Nov. 6, 2024

Related U.S. Application Data
(60) Provisional application No. 63/340,628, filed on May 11, 2022.

(51) Int. Cl. B01D 46/00; B01D 46/10; F04D 17/08; F04D 29/70; H01M 8/04014; H01M 8/0612; H01M 8/0662

(52) U.S. Cl. CPC B01D 46/0005; B01D 46/0047; B01D 46/10; F04D 17/08; F04D 29/701; H01M 8/04014; H01M 8/0618; H01M 8/0687; B01D 2265/025; B01D 2273/30

(57) ABSTRACT

An apparatus having an air consuming mechanism therein. The apparatus has a housing having an air consuming mechanism such as a fuel cell mounted therein. At least one blower assembly is in fluid communication with an air intake and supplies air to the air consuming mechanism. The blower intake has a filter, such as an N95 filter. The blower and filter have attachment structures adapted to releasably engage with each other.

### FIELD OF THE INVENTION

The invention relates to a filter assembly, and more particularly to a filter assembly for an air blower, particularly an air blower for use in a fuel processing apparatus, such as a fuel reformer, fuel cell system, fuel combustor and the like, in need of a flow of air or other oxygen containing gas. As used herein, the term air will include ambient air that may be enriched with oxygen or diluted with nitrogen or otherwise.

### BACKGROUND OF THE INVENTION

Exothermic mechanisms, such as catalytic oxidation, combustion, fuel reformation or fuel cell devices, are often controlled with various electronic systems. Often, gas flow valves and blower speeds need to be controlled to regulate a chemical reaction properly. It can be important to shield the electronics from the heat given off by these mechanisms. It can also be important to isolate the heat given off from these mechanisms so that they can be more conveniently integrated into their surrounding environment. For example, internal combustion engines, fuel cells and fuel reformers produce a considerable amount of heat. This can present a difficulty when trying to locate these mechanisms in close proximity to individuals, or within a habitat, dwelling, office or other inhabited structure. The excessive heat can also present difficulties when trying to provide a compact device with a compact housing, wherein portions of the mechanism, such as electronics must be close, proximately, yet isolated thermally.

Fuel consuming devices can also require precise airflows to insure that the oxidation of the fuel proceeds in a well-controlled manner. For example, blowers for supplying air to these devices are often controlled by electronics that receive information from sensors, monitoring devices, and the like. Some of these electronics and other Balance of Plant (BOP) components need to be protected from the heat given off by the devices they are controlling.

The constructions of conventional heat producing mechanisms, such as internal combustion engines, fuel cells and fuel reformers have presented additional difficulties, which make it difficult to integrate these mechanisms into an inhabited environment. Also, the need to protect electronics and other components from heat given off by the devices can complicate efforts to construct the apparatus in a compact manner, if too much space is taken up by physical separations of the components and electronics from the heat producing elements.

Air blowers can be useful in providing air as a source of oxygen to fuel consuming devices. Some blowers are provided with air filters. However, these filters tend to be bulky and interfere with compact constructions. It can also be inconvenient to replace these filters, and some are not adequate to filter the intake air from dust and other impurities. Many fuel cell assemblies and reformers utilize ambient air as a source of oxygen for the chemical and electrochemical reactions occurring therein, as well as for temperature control within the units. Ambient air usually includes particulates (e.g., dirt/dust), contaminants (e.g. sulfur, hydrocarbons), and/or moisture, each of which can damage highly sensitive catalytic surfaces within the fuel cell and reformer units. Existing filtration systems have not proved to be adequate for protecting these systems.

Accordingly, it is desirable to provide improved structures for a heat producing mechanisms that overcomes drawbacks of the prior art.

### SUMMARY OF THE INVENTION

Generally speaking, in accordance with the invention, an apparatus has at least two zones, at least three, or more thermal zones, each thermally isolated from the other and each within different temperature ranges. An airstream of ambient air from an air intake of the apparatus can be used to keep these zones at different temperatures, such as a cool zone and a hot zone at a temperature above the cool zone; and an intermediate zone at a temperature between the two. Preferably, the cool zone(s) is at a temperature appropriate for electronic components.

In one embodiment of the invention, the airstream passes over the outside of the apparatus to thermally isolate the outside of the apparatus from the inside, where heat is generated. In another embodiment of the invention, the airstream of the air intake is used to cool the temperature of one, two or more cool zones of the apparatus so that heat sensitive components, such as electronics are not damaged from heat produced by exothermic devices.

In one embodiment of the invention, the apparatus includes a heat producing mechanism, such as a fuel combustor, a fuel reformer, a fuel cell, or a fuel cell stack. As used herein, the term fuel cell stack can include a plurality of assembled fuel cells. Each fuel cell may generate electricity, in the form of direct current from electro-chemical reactions taking place therein. Fuel cell systems in accordance with the invention can include a fuel reforming section integrated with an electricity producing section, integrated into a single fuel cell structure. The individual fuel cells can be combined into a stack and the balance-of-plant (BOP) components can include various systems and structures for the generation of electric power, including fuel reformers, chemical reactors, gaskets, pumps, sensors, vaporizers, heat exchangers, blowers, switches, relays, thermistor's, thermocouples, conduits, control electronics, catalytic oxidizers, combustors and the like.

An airstream (including oxygen enriched airstreams) from an air intake can be used as the oxygen source of the heat producing mechanism. This airstream can be used to help keep zones and sub-zones thermally cool, despite what may be a close proximity to the heat from the exothermic mechanism. For example, a stream of ambient air can be blown or drawn over various components of the mechanism, such as electronic components, to keep those components cool. The intake air stream can also thermally isolate the outside surface of the device from the heat produced therein. This can be accomplished by drawing the intake air around the outside of the exothermic elements. This airstream can also be blown or drawn over any electronics or other elements that need to be kept cool. Excess intake air not needed for the exothermic reactions can be fed directly outside the housing

This air can then flow into the device to serve as the source of oxygen for any chemical reactions therein. However, it can be important to filter impurities from the air, it help insure that such intake air does not damage sensitive internal components, such as catalytic surfaces and the like.

In one embodiment of the invention, the exothermic mechanism can be enclosed within a double wall enclosure of a housing for the mechanism. The interior space between the outer and inner walls can act as an air intake conduit, which can function as a tube-within-a-tube construction. An array of fins can extend across the gap between the outer and inner walls, to transform this construction into an assembly of intake tubes around the entire length of the exothermic mechanism. This intake airstream can also be drawn or blown through one or more interior cool zones of the apparatus and then fed into the exothermic section of the mechanism as the source of air/oxygen. Any hot exhaust can be fed directly outside the housing and can be piped away to a convenient exhaust location. Accordingly, if the air intake is on a rear end of the device, the cool ambient air can be drawn in and drawn around the entire top and/or bottom and/or sides of the device, including the relatively cool portions of the interior thereof. The intake air can then be fed into the exothermic hot section and the exhaust can be emitted out from the rear end. The intake and exhaust can be side-by-side or concentric. For example, the intake can surround the exhaust.

In one embodiment of the invention, a housing for the device has a double wall construction, with both an inlet and an outlet at the rear end. The heat generating mechanisms can be mounted on a platform and slid in and out of a front end of the housing. A blower can be positioned towards the front end. The blower can draw cooling air into the rear end of the housing, around the length of the device through the double wall air passageway, and into a the front end of the housing. An interior zone in the front end of the housing can serve as a cool zone, where at least some of the electronics and other elements that need to be kept cool can be mounted. After passing over the outside of the apparatus housing and through the cool zone(s), the stream of intake air can be blown by; one or more blowers into the exothermic elements and then exhausted outside the device.

In accordance with the present invention, there is also provided a centrifugal blower apparatus comprising a blower unit having a blower casing having an axial inlet and a radial outlet. An impeller is disposed within the casing for drawing a gaseous medium (e.g., air) at a first pressure into the axial inlet and expelling the gaseous medium at a second higher pressure through the radial outlet. A motor is provided for driving the impeller. The blower also includes an air intake assembly. A casing has an air inlet and an air outlet. The air outlet is connected to the axial inlet of the blower casing of the blower unit. A check valve can be mounted within the casing, positioned to permit air flow from the air inlet through to the air outlet and prevent airflow from the air outlet to pass back to the air inlet.

It can be advantageous to filter the ambient air before the air enters the apparatus. A conventional mechanical filter can be used to remove the relatively large impurities. It can also be advantageous to filter the air immediately prior to feeding the air into the fuel consuming or electricity producing device to help remove particulates, volatile compounds, sulfur compounds and the like. It can be helpful to reduce moisture. The filter can be reticulated foam (low pressure drops) of some kind and potentially doped with specific materials to perform the tasks enumerated above. In a preferred embodiment of the invention, the filter can be formed from N95 certified material, including off-the-shelf N95 certified filters.

It is advantageous to include a check valve in the blower. The check valve can help prevent zero flow conditions from resulting in back flow from fans and other process air. This backflow can damage the solid oxide fuel cell (SOFC) and catalysts by oxidation. The present invention can prevent this from occurring. The check valve can be a soft elastomer that induces very little pressure drop to open and uses the slight inherent stiffness and spring constant of the material to close and seal.

The blowers feeding air into the exothermic devices are advantageously constructed as two stage blowers assembled in series. Utilizing a system of linked, multiple blowers in accordance with this invention can be useful to achieve the gas flow requirements of a fuel cell or other sensitive exothermic mechanism. A dual-blower can help enable the system to benefit from both low inertia impellers for control as well as low drive motor rpm and power draw to provide required gas flow and pressure.

Thus, an arrangement of single multiple centrifugal blowers can provide improved response times and control over a broad range of gas pressure and gas flow requirements. Fuel cell-blower assemblies featuring this arrangement of multiple centrifugal blowers are described in, e.g., U.S. Pat. Nos. 9,017,893; 9,593,686 and 9,512,846, the entire contents of each of which are incorporated herein by reference. Additional fuel cell-blower assemblies featuring an arrangement of multiple centrifugal blowers are described in, e.g., International Application No. PCT/US2012/020707, filed Mar. 16, 2015, and International Publication No. WO/2016/148681, published Sep. 22, 2016, the entire contents of each of which are incorporated herein by reference.

It can be particularly advantageous to filter the air entering the exothermic fuel consuming devices at issue herein, such as fuel reformers or a fuel cells. In preferred embodiments of the invention, air blowers are in fluid communication with intake air and filter that air before sending it to the exothermic device. Preferred blowers comprise a blower housing having an axial intake and a radial output. The intake can include a filter attachment mechanism. A a filter having an attachment portion designed to mate with and engage with the attachment mechanism of the housing can provide a releasable attachment mechanism for installing a filter over the air intake of the blowers, to filter the air just before it enters the exothermic device.

Filters in accordance with the invention can advantageously satisfy N95 standards. For example, off-the-shelf commercially available N95 filters can be employed. For improved surface area and therefore improved filtration and airflow, the filters should be dual layer filters, with internal constructions to keep the layers separated during intake filtration, so that the entire outer surface is available for air filtration and airflow, to maximize airflow per area of filter.

In preferred embodiments of the invention, an outside housing of the entire apparatus has a double wall construction, with both an inlet and an outlet at the rear end. By adjusting the dimensions of the double wall air conduit, airflow speeds can be adjusted and cooling by this airflow maximized. The heat generating mechanisms can be mounted on a platform and can be slid in and out of a front end of the housing. If the apparatus is used to produce electricity, the apparatus can remain independently connected to an installation, such as a home, R/V, office, and the like, and the core stack/BOP and electronics can be slid out of the housing for maintenance, service or parts replacement.

Fuel cell systems in accordance with the invention can be wired to power a home, R/V or other dwelling. The overall dimensions can be relatively small, 6-24″×6-24″×12-36″, with an overall length of under 4 feet preferred, as is an overall length over 6″ preferred. Fuel lines for providing reformable fuels should also be included. If liquid fuel is to be used, a vaporizer to vaporize the liquid fuel is useful.

A main blower can be positioned at the front end. The blower can draw cooling air into the rear end of the housing, around the length of the device through the double wall air passageway, and into the front end of the housing. A front interior zone in the front end of the housing can serve as a cool zone, where electronics and other elements that need to be kept cool can be mounted. After passing over the outside of the exothermic device and through the cool zone, a portion of the stream of intake air can be blown into a hot zone where the exothermic elements are located, and then exhausted outside the device. This helps with airflow balance and helps reduce the temperature of the hot zone. An additional cool zone can be provided upstream, or preferably downstream from the main blower. This flow control cool zone can house flow control blowers that electronically control the precise airflow into the exothermic elements and help control the exothermic reactions therein. In preferred embodiments of the invention, such additional electronically controlled blowers are located in this flow control cool zone, and the flow of air into this zone keeps this flow control zone cool. Filters on these flow control blowers, in accordance with the invention, help protect the exothermic elements receiving this air.

Flow control electronics preferably measure airflow resistance through the blowers, to determine whether filters on these blowers need to be changed. In preferred embodiments of the invention, the filters can be screwed on and off the intake of these blowers, for convenient replacement and secure, well-sealed attachment.

Other advantages and objects of the invention will be apparent from the drawings and descriptions to follow.

### BRIEF DESCRIPTION OF THE DRAWINGS

The following drawings are presented for illustration only, and should not be considered to limit the scope of the invention. The drawings are proportional, but other proportions are acceptable, within the spirit and scope of the invention.

FIG. 1 is a side cross-sectional schematic view of an exothermic apparatus in accordance with preferred embodiments of the invention;

FIG. 2 is a side cross-sectional view of an integrated fuel reformer and fuel cell apparatus (fuel cell) in accordance with preferred embodiments of the invention;

FIG. 3 is a bottom perspective view of an air blower and filter assembly in accordance with preferred embodiments of the invention;

FIG. 4 is a bottom perspective view of the air blower and filter of FIG. 3, with the filter disassembled from the filter housing;

FIG. 5 is a partial top perspective view of a housing for the air blower and filter assembly of FIG. 3;

FIG. 6 is a top plan view of the partial housing of FIG. 5;

FIG. 7 is a partial side view of the housing of FIG. 5;

FIG. 8 is a bottom perspective view of the filter of the housing and filter assembly of FIG. 5;

FIG. 9 is a bottom plan view of the filter of FIG. 8;

FIG. 10 is an inverted side view of the filter of FIG. 8;

FIG. 11 is a bottom perspective view of a filtered flow control blower assembly in accordance with preferred embodiments of the invention;

FIG. 12 is an exploded perspective view of the filtered flow control blower assembly of FIG. 11; and

FIG. 13 is a partial exploded view of the filtered flow control blower assembly of FIG. 11.

### DETAILED DESCRIPTION OF THE PREFERRED EMBODIMENTS

The present disclosure may be understood more readily by reference to the following detailed description of the disclosure, taken in connection with the accompanying figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention relates to exothermic mechanisms. Examples include catalytic fuel oxidizers or reformers, fuel-consuming apparatuses, fuel-processing apparatuses, and other heat generating apparatuses. These terms can encompass any exothermic apparatus based on any kind of fuel, including the apparatuses described in Ser. No. 17/267,095, filed Feb. 9, 2021, as well as in U.S. Pat. Nos. 9,627,700 and 9,627,701. The contents of this application and these patents are incorporated herein by reference. Heat generating and/or exothermic apparatuses include electric generators, fuel reformers, fuel cell systems, and the like. The expression fuel, shall be understood to include both liquid fuels and gaseous fuels, including a vaporized liquid fuels. The term fuel cell will include integrated apparatuses that reform the fuel and produce electricity.

As used herein, the term fuel cell stack can include a plurality of assembled fuel cell units. Each fuel cell may generate electricity, in the form of direct current from electro-chemical reactions taking place therein. The individual fuel cells can be combined into a stack and the balance-of-plant (BOP) components can include various systems and structures for the generation of electric power, including fuel lines, fuel vaporizers, fuel reformers, chemical reactors, gaskets, pumps, sensors, heat exchangers, blowers, switches, relays, thermistors, thermocouples, conduits, control electronics, and the like.

Examples of heat generating apparatuses in accordance with the invention include those described in U.S. Pat. Nos. 9,627,700 and 9,627,701. The entire contents of these patents are incorporated herein by reference. Fuel reformers in accordance with the invention can be configured to supply reformate, such as hydrogen-rich reformate to a fuel cell stack. The fuel cell stack may operate at a relatively high temperature for maximizing electric power generation. Furthermore, a sufficient amount of airflow can be required for the fuel cells and reformers and/or the BOP components. A portion of or all the air flow may be mixed with the fuel to provide, for example, a fuel-air mixture and hydrogen rich reformate. The airflow can also be used for the purpose of diluting the fuel or reformed fuel, to control the intensity of the chemical reactions. In addition, other electronic components of the fuel cell system can serve as heat generation sources, that are required to be cooled down for proper operation.

Accordingly, there may exist various thermal zones and thermal sub-zones of those zones, that need to be maintained at different temperatures, depending on the types and functions of the individual components therein.

As used herein, the terms hot zone and cold or cool zone are relative in nature. For example, a cold or cool zone could be well above room temperature, but below the temperature of the hot zone and below the temperature at which electronic components are destroyed. In addition, the hot zone and the cold zone can include various sub-zones of different relative temperatures.

A heat generating apparatus in accordance with preferred embodiments of the invention can include a low temperature thermal zone and a high temperature thermal zone. A heat insulating wall can be located at the interface of the two zones. The low temperature (cool) thermal zone can be in fluid communication with an air inlet, wherein a stream of ambient air is drawn into the apparatus, such as by a main blower. The high temperature (hot) thermal zone contains the a heat generating device, such as a fuel reformer, fuel cell, internal combustion engine and the like. The two zones can be separated with a heat insulating wall. An air blower can be present at the interface of the two zones, preferably in the cool zone or cool sub-zone. The air blower can draw ambient air into the cool zone and maintain the low temperature of the cool zone by the constant flow of ambient air. The blower can then blow this air into the hot zone, a cool sub-zone, or both, as required for proper operation of the exothermic reactions therein.

Ambient air can include undesirable particulates, contaminants, and/or moisture that can affect the proper operation of fuel cell assemblies and/or reformers. These particulates or contaminants can include sulfur or hydrocarbons, and/or moisture, which can damage the fuel cell and reformer units. This damage can be in the form of oxidation to the internal components, contamination of catalysts, hot spots from accumulating particulates, or rapid cooling that can cause structural defects in the components, among others.

The components of a fuel cell assembly in accordance with the invention are designed to maintain their mechanical, chemical, and/or electrical integrity during start up and normal operating modes as exposed to the high operating temperatures. During cool-down periods, e.g., transitioning into a low power mode or power down procedure, problems can arise. For example, when the system is cooling down, the air inside a fuel cell assembly can condense and create a vacuum in the fuel cell assembly that can continue to draw outside air in through an air inlet and/or exhaust. The exposure of the fuel cell assembly to this additional outside air can result in damaging oxidation or structural integrity of the fuel cell stack. Accordingly, check valves and filters in the air intake, as described herein can help prevent these problems.

Apparatuses in accordance with the invention can be constructed with the heat generating device mounted on a platform, with a housing surrounding the platform. The housing can have a two-layer dual wall, with an air intake conduit therebetween. The inner and outer layers of the two-layer wall can be segmented by a plurality of fins, running the length of the walls, to create a plurality of air passageway tube structures along the length of the two-layer wall and increase the efficiency of air flow.

An ambient air inlet can be present at a rear end of the housing and an air blower can be present inside a front end of the housing. Thus, the air can be sucked into the inlet and flow through the housing, around the outside of the entire apparatus to the front region thereof. This can create a cool zone around the outside surface of the apparatus. The rear end can also contain a cool zone, where the ambient air is drawn in. The front end can also contain a cool zone, as the ambient air flows from the air passageway to an open front end of the housing. Consequently, the cool zone can be air-flow isolated from the hot zone, across the air blower. Thus, components that need to be cool, such as electronic components, can be mounted in the cool zone (front, rear or bottom) and the outer surface of the apparatus can be kept at a relatively cool temperature.

In one embodiment of the invention, the apparatus includes a fuel cell system, with one or more fuel-processing components. These one or more fuel-processing components can include one or more balance-of-plant (BOP) components configured to supply reformate fuel mixed with air to a fuel reforming portion of a fuel cell stack. The fuel cell stack can be configured to generate electric power based on the reformate provided from reforming section. Electronically controlled blowers can be located in an airflow control zone. These blowers control the precise flow of air to the fuel cell components. These blowers can be located in a flow control zone, kept cool by the flow of ambient air therein. Any excess air blown into this flow control zone can be vented out the apparatus exhaust.

In one embodiment of the invention, the BOP components can include a flow switch unit, configured to regulate blower speeds and be shut off when airflow does not meet a preset requirement. Airflow can be measured by a flow switch unit. Airflow at one or more of the blowers can also be adjusted to maintain proper performance of the apparatus, when airflow amounts meet preset requirements. In one embodiment of the invention, an airflow switch unit can include a flat upper or differential pressure switch. A blower, preferably a dual blower that can be electronically controlled to operate at different speeds can be employed to adjust the flow of air into the exothermic device as needed. These flow control blowers of the BOP components can be mounted in a flow control cool zone, wherein a flow of air into and around the flow control blowers keeps the zone at a temperature cooler than the hot zone, in order to help protect any electronic components of the flow control system.

A housing for the apparatus can include thermal separation walls, formed of thermal insulation material, to separate the hot and cool zones and sub-zones. In addition, the cool zone(s) or the hot zone(s) can be separated into different sub-zones, maintained at different temperatures relative to each other.

In one embodiment of the invention, the fuel cell system and one or more fuel-processing components can include one or more BOP components configured to supply reformate to a fuel cell stack. The fuel cell stack can be configured to generate electric power based on the reformate provided from the one or more BOP components. The fuel cell stack can be located in a first hot sub-zone and the BOP components can be provided in a second hot sub-zone at a temperature cooler than the first hot sub-zone.

In one embodiment of the invention, the air inlet port can be positioned at the rear end of the housing and configured to draw ambient air into the cool zone. The hot zone can include a hot zone exhaust, exhausting hot gases created by the exothermic reactions therein. The hot zone exhaust can also be located at the rear of the housing. In one embodiment of the invention, the exhaust and the inlet are concentric. In one embodiment of the invention, the exhaust port is surrounded by the air inlet port. The exhaust and inlet can also be side-by-side at the rear of the apparatus.

In operation, the main blower can draw air in through the inlet, into a rear end interior of the housing, around the outside of the housing into an open front end interior of the housing. The blower can then blow the air into the hot zone, or a hot or cool sub-zone, such as a flow control zone with electronically controlled blowers for delivering air to an oxygen consuming exothermic device such as into a fuel reformation, processing or combustion apparatus. The blower can also blow the intake air into a flow control cool zone, controlling the precise flow of air to the fuel consumption/combustion/reforming device. Hot exhaust gases exit through a hot zone exhaust port. The electronic components can be located in the cool zones and the fuel processing components can be located in the hot zones of the apparatus, with the cool zones in fluid communication with the ambient intake air inlet, upstream from the hot zone(s). The hot zone can be in downstream from the air blowers, in fluid communication with the exhaust port. In one embodiment of the invention, the hot zone can be fully enclosed at the front, sides and/or rear, by at least one of the cool zones, except that the exhaust port.

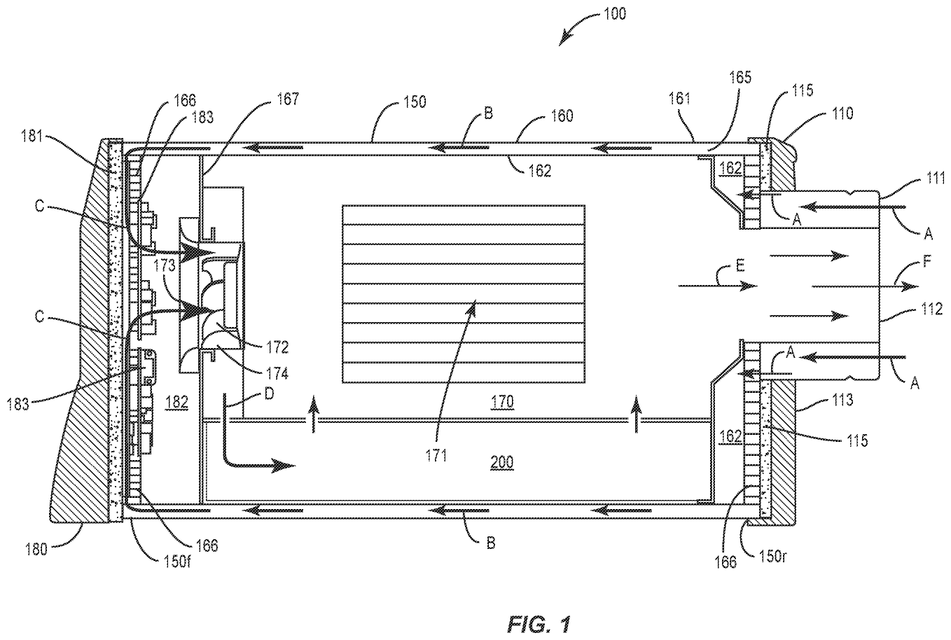

One preferred embodiment of an exothermic fuel consuming device constructed in accordance with the invention is shown generally in FIG. 1, as fuel cell 100. Fuel cell 100 includes a rear end 110, a midsection 150, and a front end at front end cap 180. Midsection 150 extends from a midsection front 150f to a midsection rear 150r thereof. Midsection rear 150r of midsection 150 is located at rear end 110 of reformer 100. Midsection front 150f of midsection 150 is located at front cap 180 of reformer 100. Reformer rear end 110 includes an inlet 111 concentric with an outlet 112, formed through a rear cap 113. Midsection 150 includes a housing cover 160 around a fuel cell 171, mounted within a hot zone 170, kept hot from the heat given off by fuel cell 171. Fuel cell 171 includes an array of fuel reforming reactors at an anode end thereof, generating a hydrogen rich reformate and a cathode end, where electricity is produced, a blower 172 for sucking air into inlet 111, and an electronics assembly 183 mounted in a cool zone 182 within front cap 183. Front cap 183 can be removably held firmly to midsection rear 150r with bolts.

Flow control blowers and electronic systems for regulating the precise flow of air into fuel cell 171 by controlling the speed of these flow control blowers can be mounted in a cool temperature flow control zone 200. Fuel cell 171, blower 172, electronics 183, and the systems (discussed below) of flow control zone 200 can all be mounted together on a mounting platform as a unit, which can be slid into and out of housing front end cap 180 for maintenance, service or parts replacement. Fuel cell system 100 can remain electrically connected to a recipient of the electricity produced thereby.

Housing cover 160 is formed with an outer wall 161 and an inner wall 162. An intake airflow housing conduit 165 is formed between outer wall 161 and inner wall 162. An array of fins 166 extend from an inner surface of outer wall 161, into housing conduit 165, to inner wall 162 and form an array of tubular conduits along the inner surface of outer wall 161.

Inner wall 162 is shorter than outer wall 161. Therefore, housing conduit 165 is exposed at rear end 150r and rear end 150r of midsection 150. A gasket 115 is present around the outside rim of an inner surface of rear cap 113. Rear end 150r of midsection 150 is pressed into gasket 115. Because inner wall 162 of midsection 150 is shorter than outer wall 161 and fins 166, interior conduit 165 is accessible at rear end 150r of midsection 150. Similarly, a gasket 181 is present around the outside rim of an inner surface of front cap 180. Thus, interior conduit 165 is also accessible at front end 150f. Consequently, an interior space is created inside rear cap 113 and front cap 180. These interior spaces are in fluid communication with housing conduit 165.

Air inlet 111 is in fluid communication with the interior defined by rear cap 113/front end 110. However, outlet 112 is sealed from the interior of front cap 113. Therefore, any air entering inlet 111 enters the interior of front cap 113, which is in fluid communication with housing conduit 165 at rear end 150r of midsection 150. Housing conduit 165 is in fluid communication with a front interior 182 enclosed by front cap 180 at front end 150f of midsection 150. An inlet end 173 of blower 172 is in fluid communication with interior 182 of front cap 180. A radial outlet 174 of blower 172 is in fluid communication with fuel cell 171. Thus, as blower 172 operates, it draws air into inlet 111 in the direction of an arrow A, along housing conduit 165 in the direction of an arrow B, and then into rear interior 182, in the direction of an arrow C. An assembly of electronics 183 are mounted in rear interior 182. Thus, intake air blows over electronics 183 prior to entering fuel cell 171, to keep electronics 183 cool in an electronics cool zone.

By virtue of intake air flowing along the outside of fuel cell 100 and into interior 182 of front end cap 180, a cool zone is formed on the outside of fuel cell 100 and at front interior 182. Therefore, the outside surface of fuel cell 100 and front interior 182, containing electronics 183 and other elements that need to be kept cool can be provided. An insulating wall 167 is provided at the rear end of electronics cool zone 182. Blower 172 is mounted on this insulating wall. Together, wall 167 and blower 172, as well as intake air flowing through conduit 165 help isolate the exothermic portions of fuel cell 100.

Blower 172 can direct the intake air into a flow control region 200 in the direction of arrow D. Air from flow control zone 200 flows to hot zone 170 and some of the air is blown directly into fuel cell 171, where it takes part in an exothermic reaction, producing a hot exhaust gas stream, traveling in the direction of arrows E. The exhaust stream and hot air warmed from the heat of exotherm of fuel cell 171 then exit exhaust 112 of fuel cell 100 in the direction of arrow F. Exhaust 112 can be elongated, so as to transport hot exhaust gases to an appropriate chimney, flue or other structure. However, because exhaust 112 is concentric within intake 111, the intake air helps isolate this heat.

Cool flow control zone 200 is in fluid communication with ambient air drawn in by blower 172. Controlled blowers in flow control zone 200 regulate the precise amount of air entering fuel cell 171. Excess air can flow around fuel cell 171.

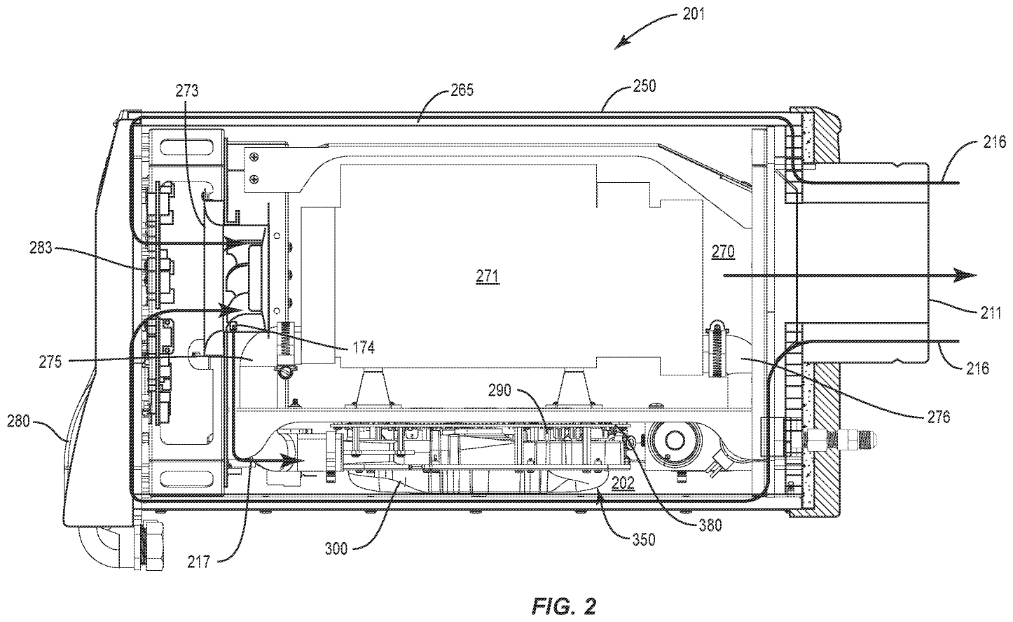

A fuel cell apparatus with a combined fuel reformer and fuel cell stack is shown generally as exothermic apparatus 201 in FIG. 2. A stream of ambient temperature intake air 216 enters apparatus 201 through an intake 211. Intake air 216 flows along a conduit 265 formed by a double wall outer housing 250, similar to the housing of reformer 100. Intake air 216 is drawn into apparatus 201 by a main blower 273. An open rear recess 282 is located at a rear end of apparatus 201. Front cap 280 is held securely against conduit 265 with bolts. An assembly of electronics 283 is mounted in rear recess 282. Intake air 216 can be directed to below over the rear end of electronics 283, past a front side of electronics 283, or both.

Apparatus 201 includes an integrated fuel reformer and fuel cell 271. The fuel reformer portion receives a flow fuel from a fuel line and a receives a flow of air through a reformer intake hose 276. The fuel cell portion producing electricity from the reformate receives a flow of air from a fuel cell hose 275. The flow of air from hoses 275 and 276 is controlled by an assembly of flow control electronics 290. Flow control electronics 290 control a flow of air from a fuel cell blower assembly 350. Flow control electronics 290 and blowers 300 are located in a flow control zone 202, located below a hot zone 270 housing fuel cell 271.

Flow control region 202 is in fluid communication with ambient intake air 216. Thus, a stream of flow control air 217 flows from blower 272 into flow control region 202 and keeps flow control region 202 as a relatively cool zone within exothermic apparatus 201. Air supply 217 provides a supply of intake air for fuel cell 271, as controlled by flow control electronics 290.

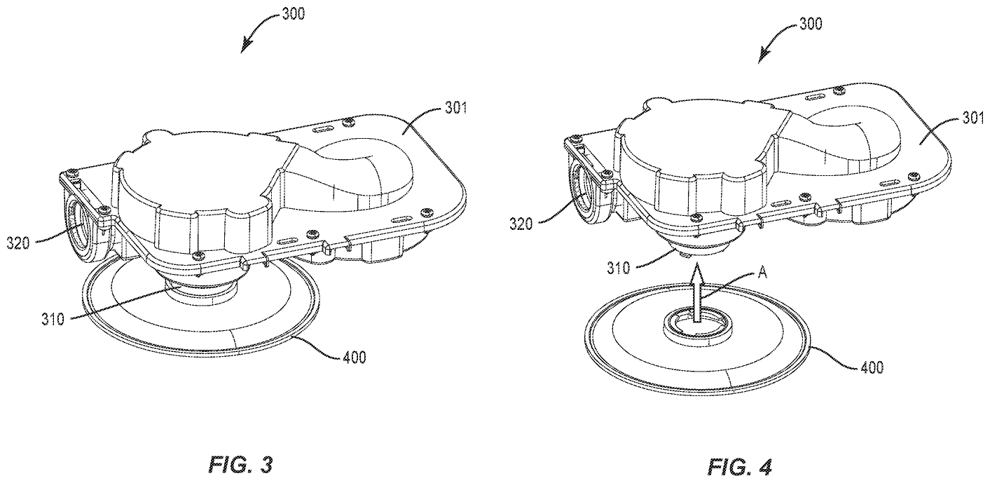

A dual fan blower 300 of blower assembly 350 is shown generally in FIGS. 3 and 4. Blower 300 includes a housing 301 with an axial intake 310 and a radial output 320. A filter 400 is shown attached to intake 310 in FIG. 3. Filter 400 is shown detached from intake 310 in FIG. 4. Filter 400 mates with intake 310 in the direction of an arrow A. Accordingly, any air fed to the fuel cell 271 can be filtered. A preferred filter meets the requirements for N95 certification.

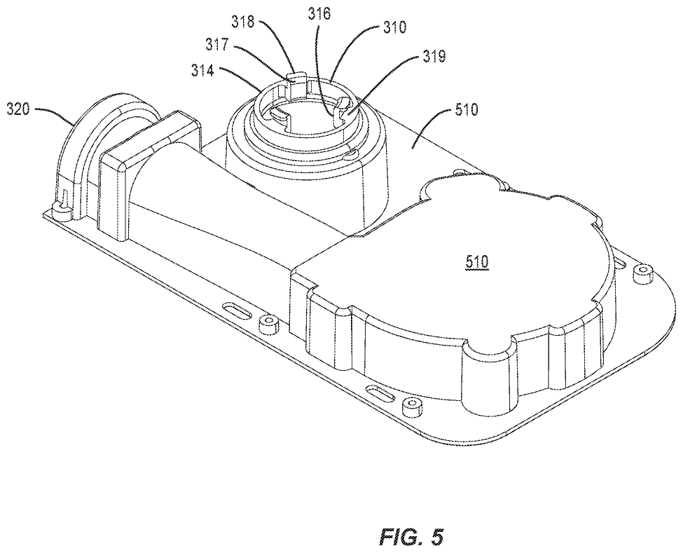

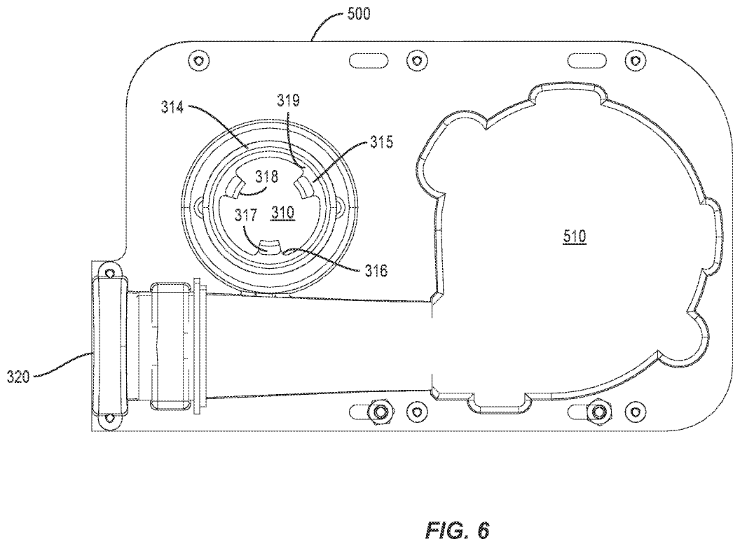

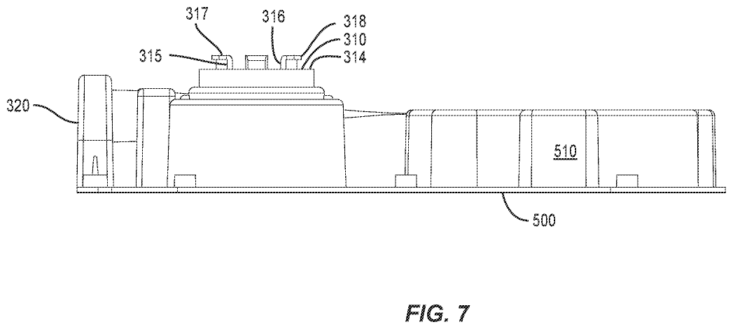

A top perspective view of a part of a blower housing 500 of blower 300 is shown in FIG. 5. A top plan view of housing 500 is shown in FIG. 6, and a side view of housing 500 is shown in FIG. 7. Housing 500 includes a fan region 510, for housing an electronically controlled fan (not shown) to draw air into intake 310 and blow the air out of outlet 320.

Inlet 310 is configured to releasably secure filter 400 thereto. Inlet 310 is circular, and has a plurality (three) of prongs 315 extending outward therefrom. Each prong 315 has a base 316 extending axially up from inlet 310, a smooth transition portion 317 and a hook portion 318 extending radially from transition portion 317. Each prong 315 is offset into the center of inlet 310 at a shelf 319. Because prongs 315 are offset into the center of inlet 310, inlet 310 can present an uninterrupted circular base 314 for an effective seal with filter 400.

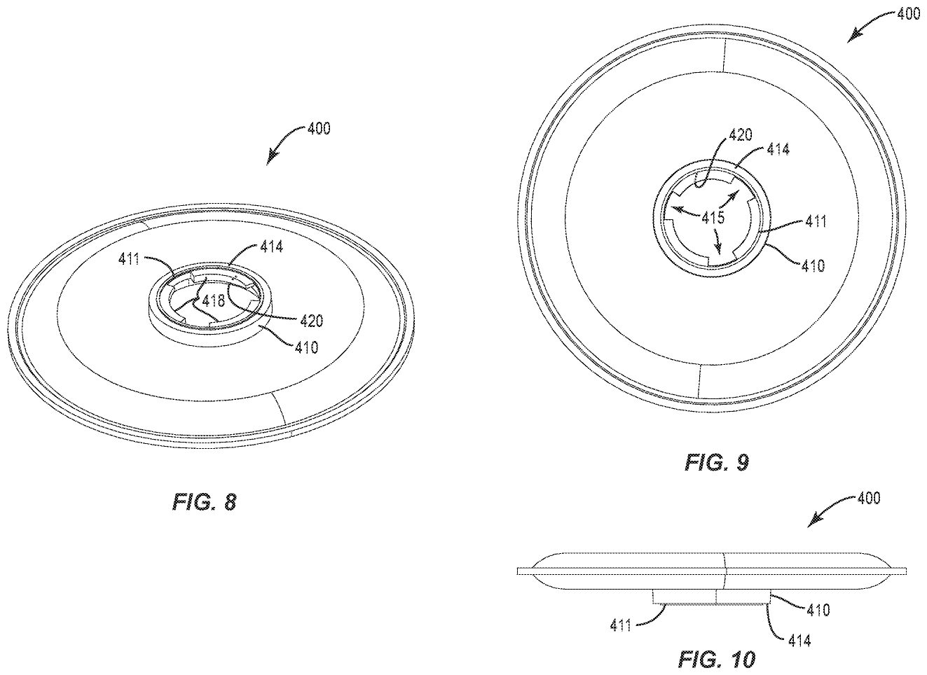

Filter 400 is shown in bottom perspective view, bottom plan view, and side view in FIGS. 8, 9, and 10, respectively. Filter 400 includes a central attachment portion 410, which extends axially from a bottom surface of filter 400. Attachment portion 410 includes a circular engagement shelf 414 for engaging with and sealing against base 314 of housing 500 of blower 300. Filter 400 also includes an engagement lip 411 which nests inside the inner surface of base 314, to help seal filter 400 against air inlet 310.

Central attachment portion 410 of filter 400 also includes a plurality (three) of engagement slots 415 for receiving the respective (e.g., 3) of prongs 315 of blower housing 500. Attachment portion 400 also includes a plurality (three) of camming ribs 418. To attach filter 400 to blower 300, attachment portion 410 is pressed up in the direction of arrow A (FIG. 4) against inlet 315. Filter 400 is then rotated radially, until hooks 318 of prongs 315 of housing 500 pass down through slots 415 of filter 400. An upper surface 420 of camming ribs 418 is inclined. A left end of each camming rib 418 is farther into the interior of filter 400, away from the surface of engagement shelf 414, than the right end. Therefore, after prongs 315 are inserted down through slots 415, filter 400 is rotated. This places the upwardly facing surface of hooks 318 against the thin/low downwardly facing surface of camming ribs 418. As filter 400 is further rotated, the engagement of the downward facing surface of lower surface 420 comes into tighter engagement with the upwardly facing surface of hooks 318, to tighten the engagement between engagement shelf 414 of filter 400 and base 314 of inlet 310 to provide an effective seal between filter 400 and inlet 310 of blower 300.

Filter 400 can be formed of any suitable filter material. It is preferably a two layer filter with space between the layers for increased surface area and therefore increased filter surface for airflow filtration into inlet 310. It is preferred that filter 400 conform to N95 certification standards. It is also preferred to construct filter 400 to keep a top and a bottom surface of filter 400 separated, so that air can be filtered through both the top and the bottom surface, before flowing into inlet 310.

Flow control electronics 290 includes sensors for measuring air flow. These sensors will be able to detect whether filter 400 becomes too clogged for adequate air flow and/or proper filtration. In this case, electronics 290 can activate a warning signal, such as a flashing light and/or audible signal. At this point, exothermic apparatus 201 can be shut down and filter 400 replaced. This can be effected by rotating filter 400 in the opposite direction, to slide hooks 318 towards slots for 15, whereby filter 400 can be removed from inlet 310 in the direction opposite arrow A.

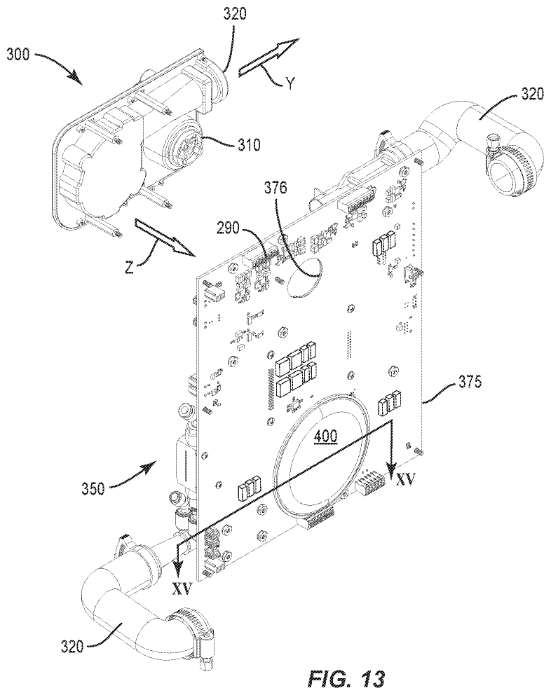

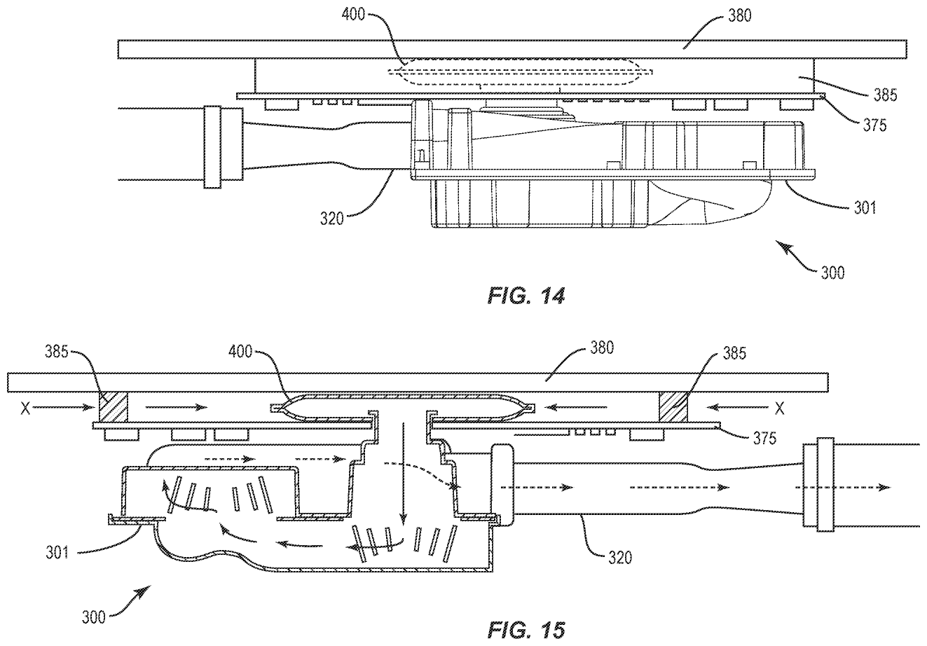

The attachment of blower 300 to printed circuit board (PCB) 375 is depicted more clearly in FIG. 13. Circuit board 375 includes a hole 376 for receiving the axial intake 310 of blower 300. Blower 300 is mounted on board 375 in the direction of an arrow Z, with axial intake 310 inserted into hole 376. Then, filter 400 is attached to the exposed axial intake 310 extending through hole 376, to present a filtered air intake for the air received by blower 300 to supply filtered air to fuel cell 271, as controlled by flow control circuitry 290.

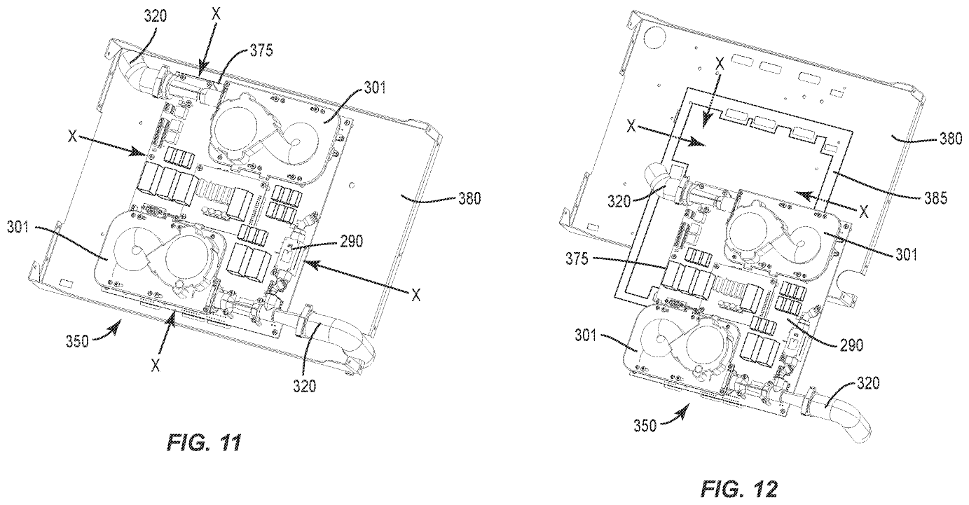

Referring to FIGS. 12 and 13, an assembly of blowers 300 and control circuitry 290 are mounted on circuit board 375. A BOP support panel 380 is used to mount PCB 375 within flow control region 202 of exothermic apparatus 201. FIG. 11 is a bottom perspective view of PCB 375 attached to support panel 380, with an exploded view in FIG. 12. An air filter gasket 385 is sandwiched between the top of PCB 375 and support panel 380. Support panel 380 is secured within flow control region 202. Filter gasket 385 permits airflow in the direction of arrow X to reach filter 400. If filter 385 is coarser than filter 400, it will act as a primary filter and prevent filter 400 from being clogged with larger particles than can be filtered out with filter gasket 385. Note that in certain embodiments of the invention, an N95 certified filter need not be used. In fact, certain embodiments of the invention can omit filter 400 and merely use filter gasket 385 around the outside edge of the PCB/plate interface.

Airflow through blower 300 is shown more clearly in FIGS. 14 and 15. Air from relatively cool flow control zone 202 is drawn by blower 300 through filter 385 in the direction of arrow X. Filter gasket 385 can act as a primary filter and retain the larger particles, to prevent those particles from reaching and clogging filter 400. This helps prolong the life of filter 400. After passing through filter 385, the air flows between panel 380 and board 375. Due to the narrow dimensions, the flow speed can be high. This improves heat transfer, which helps keep board 375 cool. After passing between board 375 and panel 380, the air is drawn through filter 400. The gap between board 375 and panel 380 can be sized wider than the height of filter 400 to permit airflow both above and below filter 400, so that all of filter 400 can be used for filtration. After passing through blower 300, the air is directed through outlet 320 and eventually to fuel cell 271.

Note that where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claims.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. An apparatus having a heat producing exothermic mechanism therein, comprising:
a housing having an exterior surface and an interior surface defining a housing interior, the housing having a front and a rear, and a length from the front to the rear, the exothermic mechanism mounted within the housing interior, and having an air intake port;
an air intake conduit in fluid communication with a source of ambient air at an air inlet of the housing;
a blower assembly having a blower with a blower intake in fluid communication with the air intake conduit, and a blower outlet in fluid communication with the air intake port of the exothermic mechanism;
the blower intake having a filter thereon, adapted and positioned to filter the air from the air intake conduit.

2. The apparatus of claim 1, wherein the filter is an N95 certified filter.

3. The apparatus of claim 1, wherein the blower assembly comprises a second blower in series with the first blower, and each blower has a fan impeller operated by a motor.

4. The apparatus of claim 1, wherein the blower has an annular shelf around the blower intake, configured and adapted to releasably attach to the filter.

5. The apparatus of claim 1, wherein the filter has an outer filtering intake surface in fluid communication with a filter interior, and a filter outlet in fluid communication with the filter interior, the filter having an annular shelf around the end of the filter outlet, sized and configured to mate with the blower intake.

6. The apparatus of claim 5, wherein the blower intake comprises at least one prong, configured to engage a mating surface of the filter outlet.

7. The apparatus of claim 5, wherein the blower intake comprises three prongs configured to engage a mating surface of the filter outlet.

8. The apparatus of claim 5, and wherein the filter outlet comprises at least one camming surface, adapted to engage the at least one prong of the filter inlet.

9. The apparatus of claim 8, wherein the camming surface is inclined and adapted such that rotating filter with respect to the blower inlet tightens or loosens the engagement between the filter outlet and the blower inlet.

10. The apparatus of claim 6, wherein the prongs are offset into an interior of the blower inlet.

11. The apparatus of claim 5, wherein the filter outlet comprises at least one prong, configured to engage a mating surface of the blower inlet.

12. The apparatus of claim 5, wherein the blower inlet comprises at least one camming surface, adapted to engage the at least one prong of the filter outlet.

13. The apparatus of claim 1, wherein electronic controls of the blower assembly are mounted in close proximity to the blower assembly.

14. The apparatus of claim 5, wherein the filter has a first layer and a second layer, with a gap therebetween and the filter interior comprises the gap.

15. The apparatus of claim 1, wherein the filter is disk shaped.

16. The apparatus of claim 15, wherein the filter is about 1-10 inches in diameter.

17. The apparatus of claim 16, wherein the filter is about 3-7 inches in diameter.

18. An apparatus having an air consuming mechanism therein, comprising:
a housing having an exterior surface and an interior surface defining a housing interior, the housing having a front and a rear, and a length from the front to the rear, the air consuming mechanism mounted within the housing interior, and having an air intake port;
an air intake conduit in fluid communication with a source of ambient air at an air inlet of the housing;
at least one blower assembly having a blower with a blower intake in fluid communication with the air intake conduit, and a blower outlet in fluid communication with the air intake port of the air consuming mechanism;
the blower intake having a filter, such as an N95 filter and/or two layer filter with a gap between the layers thereon, adapted and positioned to filter the air from the air intake conduit.
the blower having an annular shelf around the blower intake, configured and adapted to releasably attach to the filter outlet, the filter having an outer filtering intake surface in fluid communication with a filter interior, and a filter outlet in fluid communication with the filter interior, the filter having an annular shelf around the end of the filter outlet, sized and configured to mate with the blower intake;
the blower intake comprising at least one prong, configured to engage a mating surface of the filter outlet;
the filter outlet comprising at least one camming surface, adapted to engage the at least one prong of the filter inlet, wherein camming surface is inclined and adapted such that rotating the filter with respect to the blower inlet tightens or loosens the engagement between the filter outlet and the blower inlet.
